(19) United States
(12) Patent Application Publication
(10) Pub. No.: US 2026/0058291 A1
(43) Pub. Date: Feb. 26, 2026

(54) ELECTROCHEMICAL ENERGY STORAGE ELEMENT

(71) Applicant: VARTA Microbattery GmbH, Ellwangen Jagst (DE)

(72) Inventor: David Ensling, Ellwangen (DE)

(21) Appl. No.: 19/300,724

(22) Filed: Aug. 15, 2025

(30) Foreign Application Priority Data
Aug. 26, 2024 (EP) 24196554.0

(51) Int. Cl. H01M 50/342; H01M 10/04; H01M 50/107; H01M 50/167; H01M 50/521

(52) U.S. Cl. CPC H01M 50/342; H01M 10/0431; H01M 10/0481; H01M 50/107; H01M 50/167; H01M 50/521

(57) ABSTRACT

An electrochemical energy storage element has a winding assembly with at least two electrode strips wound spirally around a winding axis and at least one separator strip arranged between the electrode strips. The winding assembly has two terminal end faces and an axially aligned cavity in its center. A winding core is arranged in the cavity. In order to increase the safety of the energy storage element, an anchor element is arranged on at least one of the two terminal end faces, the anchor element being connected to the winding core. The anchor element projects laterally from the axial center of the winding assembly at least in certain regions over the end face of the winding assembly.

### CROSS REFERENCE TO RELATED APPLICATIONS

This application claims benefit to European Patent Application No. EP 24196554.0, filed on Aug. 26, 2024, which is hereby incorporated by reference herein.

### FIELD

The present disclosure relates to an electrochemical energy storage element having a cylindrical housing and a hollow cylindrically shaped winding assembly. The present disclosure further relates to a method of manufacturing such an electrochemical energy storage element.

### BACKGROUND

The simplest form of an electrochemical energy storage element is the electrochemical cell. An electrochemical cell comprises at least one positive electrode and at least one negative electrode, which are connected via an ion-conducting electrolyte. In such a cell an electrochemical, energy-supplying reaction takes place, which is composed of two electrically coupled but spatially separated partial reactions. One partial reaction, which takes place at a comparatively low redox potential, takes place at the negative electrode and one at a comparatively high redox potential at the positive electrode. The spatial separation is often ensured by a separator arranged between the electrodes.

During discharge, electrons are released at the negative electrode as a result of an oxidation process, resulting in a flow of electrons via an external load to the positive electrode, from which a corresponding amount of electrons is absorbed. A reduction process therefore takes place at the positive electrode. At the same time, an ion current corresponding to the electrode reaction occurs within the electrochemical cell for the purpose of charge equalization. This is ensured by the ion-conducting electrolyte.

In secondary (rechargeable) electrochemical energy storage cells, the discharge reaction is reversible, i.e. it is possible to reverse the conversion of chemical energy into electrical energy during discharge.

When the terms “anode” and “cathode” are used in connection with secondary electrochemical energy storage cells, the electrodes are generally named according to their discharge function. The negative electrode in such cells is therefore the anode and the positive electrode is the cathode.

An electrochemical energy storage element can comprise exactly one electrochemical energy storage cell. However, it can also comprise two or more cells, which are preferably electrically connected in series or electrically connected in parallel.

In energy storage elements, the electrodes and separators are often provided in the form of assemblies. Such an assembly can be a cell stack consisting of stacked electrodes. However, the assembly usually has a structure of wound electrodes and separators (winding assembly).

Cylindrical designs are widely used for electrochemical energy storage elements, whereby the electrodes are generally located as part of a hollow cylindrical winding assembly in the interior space of a cylindrical housing, for example with a form factor of 21×70 (diameter*height in mm). Cells with such a form factor are commonly known as cylindrical round cells.

For applications in the automotive sector, for e-bikes or also for other applications with high energy requirements, such as in electric tools, lithium-ion cells with the highest possible energy density are preferred, which are at the same time capable of being loaded with high currents during charging and discharging. Modern lithium-ion cells of this form factor can achieve an energy density in a range from 300 Wh/kg.

### SUMMARY

In an embodiment, the present disclosure provides an electrochemical energy storage element. The electrochemical energy storage element includes a hollow, cylindrically-shaped winding assembly comprising at least two electrode strips wound spirally around a winding axis and at least one separator strip arranged between the at least two electrode strips. The winding assembly has two terminal end faces, a circumferential outer assembly shell surface, and a circumferential inner assembly shell surface. The inner assembly shell surface defines an axially aligned cavity in a center of the winding assembly. The electrochemical energy storage element further includes a winding core with an essentially cylindrical or hollow-cylindrical shape. The winding core is arranged in the axially aligned cavity, and the winding core has an outer peripheral surface. The electrochemical energy storage element further includes an anchor element arranged on at least one respective terminal end face of the two terminal end faces of the winding assembly and connected to the winding core. The anchor element projects laterally from the axial center of the winding assembly over the respective terminal end face at least in certain regions.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic sketch of a still unwound anode electrode strip;

FIG. 2 is a schematic sketch of a still unwound cathode electrode strip;

FIG. 3 is a schematic sketch of a staggered arrangement of anode, separator and cathode in the unwound state;

FIG. 4 is a perspective view of a winding assembly with a protruding anode current collector at the top and a protruding cathode current collector at the bottom and a winding core inside;

FIG. 5 is a perspective view of a winding assembly including a winding core and an end face anchor element according to a first example;

FIG. 6 is a longitudinal section through the winding core and the anchor element assembled with it from FIG. 5;

FIG. 7 is a top view from below of the anchor element from FIGS. 5 and 6;

FIG. 8 is a perspective view of a winding assembly including a winding core and an end face anchor element according to a second example;

FIG. 9 is a longitudinal section through the winding core and the anchor element assembled with it from FIG. 8;

FIG. 10 is a top view from below of the anchor element from FIGS. 8 and 9;

FIG. 11 is a longitudinal section through an electrochemical energy storage cell with a closed housing and an inserted winding assembly;

FIG. 12 is a longitudinal section through an electrochemical energy storage cell in a state in which a lid assembly has become detached from the housing and the winding assembly together with the winding core and anchor element is ejected;

FIG. 13 is a section through a cell array with several energy storage cells, whereby one of the energy storage cells is ejected;

FIG. 14 is a top view of a cell connector that electrically connects two energy storage cells of the cell array; and

FIG. 15 is a sectional view of a cell array during a disassembly step during recycling of the energy storage cells.

### DETAILED DESCRIPTION

One problem with electrochemical energy storage elements with a very high energy density is that strong thermal dynamics can occur in the event of an electrical short circuit or other misuse conditions, for example. This can cause the chemical materials of the cell, especially the electrolyte and the active materials, to react violently and evaporate abruptly, which can even cause the housing of the energy storage element to burst. Such a thermal runaway of an energy storage element can pose a safety risk.

If several energy storage elements are combined to form an array, the thermal failure of one energy storage element can also propagate very quickly to neighboring energy storage elements, so that the array as a whole fails and poses a considerable safety risk due to the associated heat generation.

It is known that the use of active materials in cylindrical energy storage elements that undergo a noticeable change in volume, also known as volume thrust, during charging or discharging is problematic. This is particularly pronounced with materials containing Si, for example. Continuous growth of the solid electrolyte interphase (SEI), a type of passivation layer on the anode, can also contribute to swelling of the electrode. The volume change thus comprises both reversible “breathing contributions” and continuous growth. Many efforts are therefore being made at material, electrolyte and electrode level to minimize these volume effects. In winding assemblies the winding can even collapse towards the inside of the winding. In order to prevent/reduce this or to stabilize the winding, the prior art uses, for example, tubes as winding cores (also known as mandrels). The winding cores are either included as part of the winding process right from the start or inserted subsequently. The winding cores can consist of a metallic material, e.g. Cu, but polymer-based materials are also frequently used. An energy storage element with a winding core is known, for example, from EP 3 945 617 A1.

In the case of energy storage elements having a winding core, however, the safety risk is additionally elevated in the event of thermal failure by the fact that the winding core can be shot out of the interior of the energy storage element like a projectile.

The present disclosure provides an improved energy storage element that addresses aforementioned problems. In particular, the present disclosure provides an energy storage element and an array of energy storage elements that are improved in terms of its safety properties.

An energy storage element according to an embodiment has the following features:
a) The energy storage element has a hollow cylindrically shaped winding assembly which has a spiral structure comprising at least two electrode strips wound spirally around a winding axis and at least one separator strip arranged between the electrode strips.
b) The hollow cylindrically shaped winding assembly comprises two terminal end faces, a circumferential outer assembly shell surface and a circumferential inner assembly shell surface.
c) The inner assembly shell surface defines an axially aligned cavity in the center of the winding assembly.
d) A winding core with an essentially cylindrical or hollow-cylindrical shape is arranged in the axially aligned cavity, wherein the winding core has an outer peripheral surface, which preferably lies flat against the inner assembly shell surface.

The energy storage element is characterized by the following features:
e) An anchor element, which is connected to the winding core, is arranged on at least one of the two terminal end faces of the winding assembly.
f) The anchor element projects laterally from the axial center of the winding assembly at least in certain regions over the end face of the winding assembly.

The anchor element, which is connected to the winding core, prevents the winding core from being catapulted out of the cell as a projectile in the event of thermal failure of the energy storage element. The fact that the anchor element projects laterally over the end face of the winding assembly facilitates the formation of a structural unit including the winding core and the winding assembly with regard to ejection out of a housing part. Due to the increased mass that is ejected during thermal failure, the speed of the ejected material is reduced at the same ejection pressure. This elevates the safety of the energy storage element, as the “projectile effect” is eliminated. Above all, however, the thermally critical contents of the cell are removed from the plane of a cell array (see further explanations below)—ideally completely. This significantly reduces the probability of thermal propagation in a cell array and significantly improves the safety of the overall system.

By projecting over the end face of the winding assembly, a radial extension of the anchor element is provided over at least one region of the winding assembly, which creates a form fit in the axial direction between the anchor element and the winding core connected to it on the one hand and the winding assembly on the other. The anchor part therefore moves along with the winding composite body as the winding core moves, thereby preventing any relative motion between the two components.

The feature “cylindrical” is not necessarily regarded here as circular-cylindrical, but is understood here in the general mathematical sense and can thus also comprise bodies with a polygonal base surface, for example a hexagonal prism, or a non-circular-cylindrical base surface, for example a compressed flat winding.

Preferably, the electrochemical energy storage element is an electrochemical energy storage cell.

In preferred examples, the anchor element is characterized by at least one of the following features a) to e).

a) The anchor element and the winding core are integrally formed from the same material.

This offers particular advantages in manufacturing. The anchor part and the winding core can thus be produced as a single, materially integral component, for example as a plastic injection-molded part. This component is then inserted into the winding composite body without any further joining process steps.

However, the anchor part and the winding core may also initially be separate components that are subsequently joined. For instance, the winding core may already be inserted into the winding composite body, and the anchor part may then be attached to the winding core, for example by gluing or welding. Mechanically interlocking, form-fitting connections between the anchor part and the winding core are also conceivable.

b) The anchor element is formed as one or more bent tabs of the winding core.

An efficient manufacturing method can be achieved by designing a hollow cylindrical winding core with some protrusion over the end face of the winding assembly. In the region of the protrusion from the end of the winding core, the winding core has at least two longitudinal incisions that are approximately opposite each other. This provides two separate tabs, which are bent outwards after the winding core has been inserted into the winding assembly so that they project over the end face of the winding assembly. The length of the incisions determines the extent to which the anchor element projects from the center of the winding assembly over the end face.

An efficient method of manufacture can be achieved by designing a hollow cylindrical winding core to protrude slightly beyond the end face of the winding assembly. In the region of this protrusion, the winding core comprises at least two approximately opposing longitudinal slits extending inward from its free end. This creates two separate tabs which, after insertion of the winding core into the winding composite body, are bent outward so as to project over the end face of the winding assembly. The length of the slits determines the extent to which the anchor part protrudes from the center of the winding assembly beyond its end face.

c) The anchor element has two, three or four arms, preferably arranged in a star shape.

If several longitudinal incisions are provided, this results in a correspondingly higher number of tabs, so that a plurality of tabs project over the end face of the winding assembly.

However, the anchor element can also be formed as a cross component that is connected to the anchor element, for example with four arms. The number of arms is therefore independent of the manufacturing method. Furthermore, the arms of the anchor element can take on any shape. Designs with leaf-shaped arms are therefore also conceivable.

d) The anchor element is formed as a disk.

A disc-shaped anchor element has the advantage that the end face can be contacted over as large an area as possible. This results in a large area for the positive fit between the anchor element and the winding assembly.

e) The anchor element extends from the axial center if the winding assembly to a radius that ranges between 10% and 100% of the radius of the winding assembly, preferably between 30% and 98%, in particular between 80% and 95%.

To ensure the necessary form-fit between the anchor part and the winding assembly during ejection from a housing, it is not essential for the anchor part to extend across the entire radius of the end face of the winding assembly. It has been found that it is already sufficient if the anchor part extends only up to 10% of the radius of the winding assembly. Ideally, however, the coverage is greater—for example up to 60%, 80%, or 90%, or close to full coverage. The stated radial values are independent of the shape of the anchor part, such that either a disk-shaped anchor part or the arms or tabs thereof may protrude correspondingly far over the end face. Moreover, it is also possible for the anchor part to extend beyond the radius of the winding assembly. However, such a configuration is not advantageous in terms of the overall space requirements of the energy storage element.

According to a further preferred example, the anchor element is characterized by the following feature.

a) The anchor element is an electrically conductive contact element which is in direct contact with one of the electrode strips at the end face of the winding assembly on which the anchor element is arranged.

Energy storage elements designed specifically for high current-carrying capacity may comprise a contact element for contacting the electrode strip at the end face of the winding composite body. Such energy storage elements are known, for example, from WO 2021/239492 A1. This contact element can also serve as an anchor part for the winding core. For this purpose, it merely needs to be connected to the winding core, or be joined to it during the manufacturing process. Since the contact element is typically welded directly to the edge of the electrode strip at the uncoated metal carrier of the active electrode material, the contact element can preferably also be welded or mechanically connected to the winding core. In this way, the preferred dual function of the component—as a contact element for the electrode strip and as an anchor part for the winding core—can be realized in a single manufacturing step.

According to a further preferred example, the energy storage element is characterized by the following feature.

a) The energy storage element comprises a housing which comprises a preferably metallic, cup-shaped housing part with a bottom and with a terminal opening which is closed by a lid assembly.

As will become apparent below, the anchoring of the winding core to the winding assembly is advantageous in energy storage elements that have a cup-shaped housing part closed by a lid assembly. In such housings, the lid assembly can open in the event of thermal failure, allowing the unit composed of the winding core, anchor part, and winding assembly to be ejected.

In such a housing, the energy storage element can be characterized by one of the following features.

a) The winding core is connected to the bottom of the housing part in such a way that the bottom forms the anchor element.

If the winding assembly is connected directly to an electrically conductive bottom, for example by welding, the winding core may likewise be connected directly to the bottom. In this case, the bottom forms the anchor part, which prevents the winding core from being ejected from the housing—detached from the winding assembly—in the event of a thermal failure of the energy storage element. The advantage of this solution is that no separate component is required.

b) The anchor element is connected to the bottom of the housing part.

Alternatively, the anchor part may be a separate component connected to the bottom of the housing part. This is advantageous, for example, in conjunction with the aforementioned feature whereby the anchor part also serves as an electrically conductive contact element. It is often common practice to connect the contact element, which is connected to the cathode current collector, to the bottom of the cup-shaped housing part. In this way, the cup-shaped housing part functions as the terminal of the energy storage element. In such an embodiment, the contact element can simultaneously serve as the anchor part if it is welded to the winding core. The connection—which may likewise be a welded connection—is then designed to release more easily than the connection to the winding core, which is ideally very robust.

According to a further example, the energy storage element has the following additional features.

a) The anchor element has through openings via which a gas pressure arising in the winding assembly can be released into a space between the bottom and the anchor element in such a way that

b) the gas pressure presses the anchor element together with the winding core and the winding assembly against the lid assembly.

In the event of a thermal failure, pressure arising in the winding assembly can quickly escape into the space between the anchor element and the bottom. Due to the ejection of entrained material and the gas escaping through the through openings, the winding assembly is accelerated like a rocket and ejected from the cup-shaped housing part as soon as the lid assembly is opened. However, the speed of the winding assembly during ejection is comparatively low, so that this does not pose any further danger. Essentially, a large part of the mass contained in the storage element should be ejected from the housing in order to prevent thermal propagation to neighboring storage elements.

According to an advantageous example of embodiment, the electrochemical energy storage element may have at least one of the following additional features.

a) The lid assembly is attached to the cup-shaped housing part, in particular by a crimping closure technique, in such a manner that the closure of the lid assembly opens as soon as the internal pressure and/or the winding composite body presses against the lid assembly with a predetermined threshold pressure.

If the closure of the lid assembly is configured accordingly on the cup-shaped housing part, it is possible to prevent the cup-shaped housing part from rupturing. This constitutes a controlled pressure relief of the energy storage element. The threshold pressure at which the lid assembly opens is advantageously set higher than the pressure at which a so-called pressure relief valve (PRV) according to the prior art opens. In addition, the opened lid assembly should preferably expose the largest possible clear cross-section.

The following feature is therefore a further additional or alternative feature.

b) The lid assembly (66) is attached to the cup-shaped housing part (62), in particular by a crimping closure technique, in such a manner that the clear cross-section of the cup-shaped housing part (62) is reduced radially—in the region below the lid assembly (66)—by not more than six times the wall thickness of the housing part (62), compared to the remaining clear cross-section.

In this way, the largest possible cross-section is free to eject the complete winding assembly from the cup-shaped housing part.

In the manufacture of an energy storage element, crimping processes are conventionally used to close the cup-shaped housing part with the lid assembly. With the winding assembly already in place, the free end section of the cup-shaped housing is bent radially inwards over a region of the lid assembly. To prevent the winding assembly from being damaged during the crimping process, a tool-engaging structure is first created on the cup-shaped housing part above the winding assembly in conventional energy storage elements. The function of the tool-engaging structure is that a counter tool of a crimping tool can be attached to the cup-shaped housing part while the housing is closed by the crimping process. The counter tool holds the lid assembly in the axial direction against the axial force exerted during the crimping process and dissipates this force so that the winding remains largely free from the application of force. Usually, a circumferential bead is provided in the cup-shaped housing part at the time of closing, which also remains after manufacture.

As this bead protrudes radially into the interior space of the housing cup, the region in which the bead is formed has a reduces cross-section. This can complicate the ejection of the winding assembly, as the assembly usually fills the housing cup completely in the radial direction.

In contrast to this conventional crimp closure technique, the above-mentioned crimp closure technique makes it possible to dispense with the tool engagement structure that is usually required for the counter tool.

For details of the crimp closure technique, reference is made to the applicant's application EP 3 916 877 A1.

In this crimp closure technique, after the winding assembly has been inserted into a cup-shaped housing part which is provided with a step or a cone, the step or the cone is transferred into a circumferential indentation by calibrating the outer diameter of the cup-shaped housing part. The lid assembly is then placed on this indentation and only an upper protrusion of the cup-shaped housing part is bent radially, i.e. crimped. Axial countering is not necessary.

As the clear cross-section of the cup-shaped housing part is only reduced radially for example by up to 6 times the wall thickness of the housing part in the region below the lid assembly, the winding assembly can be ejected from the housing part together with the winding core and the anchor element in the event of thermal failure of the energy storage element.

The region below the lid assembly can be regarded here in particular as the region directly below the lid assembly where it rests on the cup-shaped housing part.

Typical wall thicknesses are in a range from 200 μm to 350 μm for housings of type 21700.

The region of the inverted cup above the lid assembly can be larger in order to ensure retention forces to the seal or to enable end face contact of the storage element to the circumferential edge of the cup. However, if the cell is opened, this outer region can deform more easily.

The closure does not have to have a circumferential indentation, but can also have only individual contact points for the lid assembly. The information on the penetration depth or reduction of the clear cross-section therefore relates to the respective elements. In the case of a circumferential indentation, a closure technology would therefore also fall under the protection area, which would protrude into the inner cross-section by 6 times the wall thickness on two opposite sides.

Further details on closure techniques with the largest possible clear cross-section can be found in the applicant's EP24194421.4, which has not yet been published.

The housing of the energy storage element is further characterized by the following additional feature.

a) The bottom has a predetermined breaking line which separates a detachable bottom area from a bottom area which is firmly assembled to the rest of the housing part.

This has the advantage that a punch can be placed there with which the detachable base area can be pressed in. This can be used to manually eject the winding assembly and the anchor element during a recycling process.

The above-mentioned energy storage elements can preferably be designed in such a way that, due to the anchor element, between 10% and 100%, preferably between 40% and 100%, in particular more than 60%, of the volume content of the energy storage element is ejected from the housing in the event of thermal failure.

With regard to an array of electrochemical energy storage elements, the safety of the above energy storage elements can be further elevated with the following additional feature:

a) A cell connector connects lid assemblies of at least two energy storage elements, wherein the cell connector is deformable and/or detachable in such a manner that the lid assembly of one energy storage element can be opened upon reaching a predetermined threshold pressure within that energy storage element, while the lid assemblies of the other energy storage elements remain closed.

The deformability or detachability of the cell connector is advantageous in that it allows the lid assembly to be opened from a single energy storage element in which the thermal failure occurs, despite an electrically necessary connection to the neighboring element, in order to eject the winding assembly.

Such a cell connector can have special bending points, which are realized, for example, by material constrictions. Or the connection of the cell connector is only just stable enough to ensure electrical conductivity, but when the limit pressure is reached, the connection, for example a weld spot, loosens.

A method for recycling the above-mentioned electrochemical energy storage elements preferably has the following features.

a) Pressing the winding assembly out of a housing part including the winding core by pressing a punch into the bottom of the energy storage element.

b) Separately processing the housing part and the winding assembly.

Such manual ejection of the winding assembly allows easier and safer recycling of energy storage elements. In particular, the punch can press in the detachable base area, which is outlined by a predetermined breaking line.

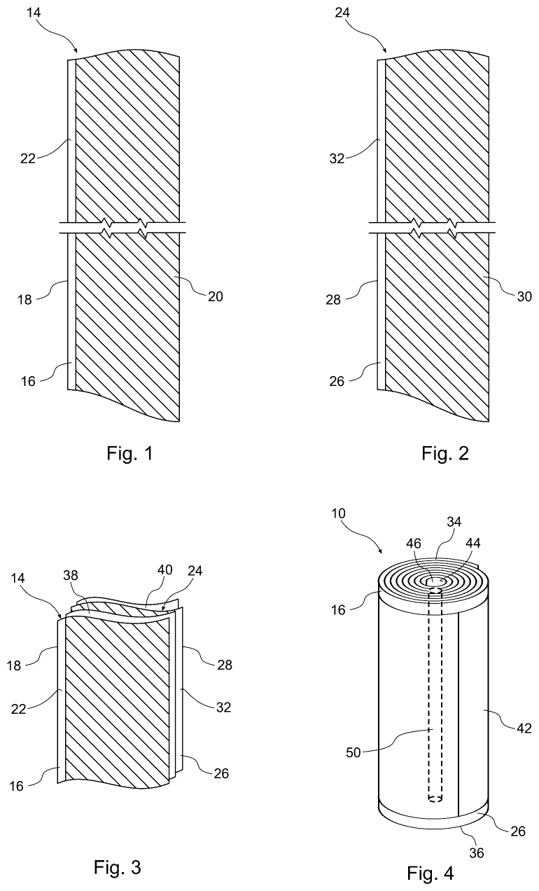

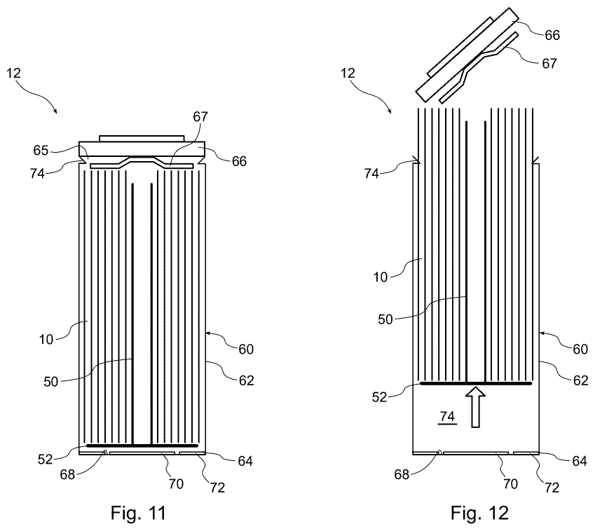

FIGS. 1 to 4 illustrate the structure of a winding assembly 10, which can be a component of an energy storage cell 12 (see FIGS. 11 to 15). Since the description only shows examples of embodiments with only one electrochemical energy storage cell as an energy storage element, the term energy storage cell is always used in the following. However, as already explained above, variants with several energy storage cells assembled to form an energy storage element are also conceivable.

The winding assembly 10 comprises the strip-shaped anode 14 shown in FIG. 1 with the strip-shaped anode current collector 16, which has a first longitudinal edge 18. The anode current collector 16 is a foil made of copper or nickel. In the case of anodes with higher potentials (>1V vs. Li/Li+) or for Na-ion cells, aluminum can also be used. The foil comprises a strip-shaped main area loaded with a layer of negative electrode material 20 and a free edge strip 22 extending along the longitudinal edge 18, which is not loaded with the electrode material 20. The edge strip 22 can be partially coated with a material for electrical insulation.

Furthermore, the winding assembly 10 comprises the strip-shaped cathode 24 shown in FIG. 2 with the strip-shaped cathode current collector 26, which has a second longitudinal edge 28. The cathode current collector 26 is an aluminum foil. It comprises a strip-shaped main region loaded with a layer of positive electrode material 30 and a free edge strip 32 extending along the longitudinal edge 28, which is not loaded with the electrode material 30.

Both electrodes, the anode 14 and the cathode 24, are initially shown individually in the unwound state.

The anode 14 and the cathode 24 are arranged offset to each other within the winding assembly 10 in such a way that the first longitudinal edge 18 of the anode current collector 16 protrudes from the first terminal end face 34 and the second longitudinal edge 28 of the cathode current collector 26 protrudes from the second terminal end face 36 of the winding assembly 10. The offset arrangement is shown in FIG. 3.

The two strip-shaped separators 38 and 40 are also shown there, which separate the anode 14 and the cathode 24 from each other in the winding assembly 10. In this context, one therefore often speaks of an electrode-separator assembly. The separator bands 38 and 40 may comprise any material for electrically separating the electrodes. In addition, they can also be applied directly to the electrodes as a type of insulating layer. For this purpose, electrically insulating, ion-conducting materials such as ion-conducting polymers are conceivable. With regard to the scope of protection of the claims, such insulating layers are therefore also regarded as separator tape.

In FIG. 4, the winding assembly 10 is shown in wound form, as it can be used in an energy storage cell 12 according to one of FIGS. 11 to 15. The anode current and cathode current collectors 16 and 26 protruding from the end faces 34 and 36 are clearly visible.

Frequently, the winding assembly 10 is still enclosed by a winding shell 42, for example by a plastic film. Alternatively, locally applied, strip-shaped adhesive tapes can also be used or the separator tapes are glued together directly in the outermost winding.

As can also be seen in FIG. 4, the winding assembly 10 is hollow-cylindrical in shape and has a circumferential outer assembly shell surface, along which the winding shell 42 essentially extends, and a circumferential inner assembly shell surface 44, which defines an axially aligned cavity 46 in the center of the winding assembly 10.

A winding core 50 is arranged in the cavity 46. This has the function of supporting the winding assembly 10 from the inside. This prevents the cavity 46 from collapsing due to the volume thrust during loading and unloading. The winding core 50 can be made of metal or polymer material. Depending on the manufacturing process, the winding core 50 can be placed inside the winding assembly 10 before winding or after winding.

In most cases, the cavity 46 has a hollow cylindrical shape with a circular cross-section. However, depending on the geometry of the winding core 50, other hollow cylindrical or solid cylindrical shapes, such as a hexagonal prismatic shape, are also conceivable. The winding core 50 is often formed as a longitudinally slotted circular cylindrical tube, so that the winding core 50 itself can yield to a certain extent to the volume thrust of the electro-separator assembly.

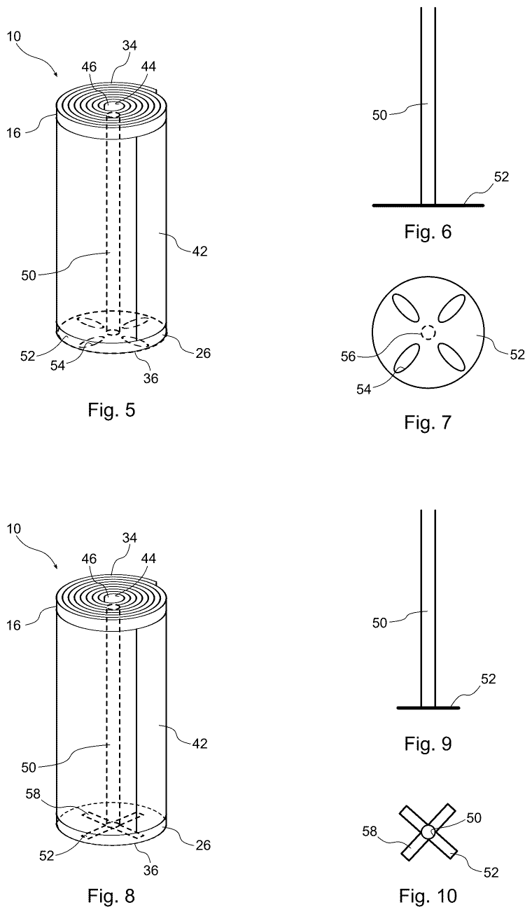

FIGS. 5 to 7 now show a first example of the further development.

FIGS. 6 and 7 show the winding core 50 and an anchor element 52, which is firmly attached to the end face of the winding core 50, in section or in a plan view.

In the example shown here, the anchor element 52 is disk-shaped and has four through openings 54. The through openings 54 are oval here, but can also have other shapes and their number can vary as desired.

Both the winding core 50 and the anchor element 52 are metallic in this example and are therefore electrically conductive. The winding core 50 and the anchor element 52 are firmly connected to each other along the weld seam 56 shown as a dashed line in FIG. 7.

In FIG. 5, the winding assembly 10 is shown with the winding core 50 inserted into the cavity 46 from the end face 36, on which the cathode current collector 26 protrudes, in such a way that the anchor element 52 projects over the end face 36 of the winding assembly 10. A form fit is thus formed between the winding core 50 and the anchor element 52 on the one hand and the winding assembly 10 on the other hand with respect to a movement of the winding core 50 in the axial direction towards the end face 34. Accordingly, the winding core 50 can only move axially (upwards in FIG. 5) together with the winding assembly 10.

Due to the fact that the anchor element 52 is electrically conductive, the anchor element 52 is also used as a contact element to the cathode current collector 26 against which the anchor element 52 rests. For better contact, the anchor element 52 is welded to the cathode current collector 26, at least in certain areas. The anchor element 52 is in turn welded to the winding core 50, the welding ensures an even more intimate connection between the winding core 50 and the winding assembly 10, as movement in the direction of the end face 36, on which the anchor element 52 is arranged, can only take place together.

FIGS. 8 to 10 show a further example. There, the anchor element 52 was formed as a result of four longitudinal cuts being made at the end face of one end of a tube. The resulting tabs were then each bent through 90°so that, as can be seen from FIGS. 8 to 10, they form star-shaped radially projecting arms 58 which form the anchor element 52. The anchor element 52 and the winding core 50 are thus manufactured in one piece and in a simple manner. Here too, the projecting arms can be welded to the collector foil over their length in order to form a contact element that electrically connects the collector foil.

FIG. 8 also shows how the anchor element 52 lies against the winding assembly 10.

FIG. 11 shows an electrochemical energy storage cell 12 with a housing 60 in which the winding assembly 10 together with the winding core 50 and anchor element 52 is arranged.

The housing 60 comprises a cup-shaped housing element 62 with a bottom 64, the terminal opening 65 of which is closed by a lid assembly 66. The lid assembly 66 also comprises the upper contact element 67, for example made of aluminum, which connects the anode current collector 16 at the upper winding end face to the rest of the lid assembly 66.

The bottom 64 has a predetermined breaking line 68, which delimits a detachable bottom portion 70 from a bottom portion 72 that is fixedly assembled to the remainder of the housing part 62.

The lid assembly 66 is attached to the housing part 62 during manufacture of the energy storage cell 12 using a novel crimp closure technique. In contrast to conventional crimping of the cup-shaped housing part 62 in order to close the lid assembly 66, the crimp closure technique narrows the clear cross-section of the cup-shaped housing part 62 significantly less.

For details of the crimp closure technique, reference is made to the applicant's parallel application EP 3 916 877 A1.

In the crimp closure technique, after insertion of the winding assembly 10 into the cup-shaped housing part 62 provided with a step or a cone, the step or the cone is transferred into a circumferential indentation 74 by calibrating the outer diameter of the housing part 62. The lid assembly 66 is then placed on this indentation 74 and only an upper projection of the cup shaped housing part 62 is radially bent over, i.e. crimped.

The indentation 74 circumferentially surrounds the side wall of the housing part 62 in an annular manner, but does not have the depth that an indentation used for conventional crimping would have to have, into which a crimping tool would engage in order to counter the lid assembly 66 in the axial direction.

The indentation 74 in the present example has a radial depth of about 2 times to about 6 times the wall thickness of the cup-shaped housing part 62 in the region of the indentation 74. This leaves a large clear cross-section in the cup-shaped housing part 62.

The energy storage cell 12 operates as follows:

In FIG. 12, the situation of a thermal failure of the energy storage cell 12 is shown.

Due to the thermal failure, for example caused by an internal short circuit, an overpressure has built up in the closed housing 60. The pressure has risen very quickly, so that a pressure relief valve (PRV) conventionally arranged in the lid assembly 66 has not been sufficient to defuse the dangerous situation.

Due to the excess pressure, as can be seen in FIG. 12, the lid assembly 66 including the upper contact element 67 is blown off and, due to the resulting dynamics, the excess pressure also flows downwards through the through openings 54 into the region 76 below the anchor element 52. As a result, the entire unit of winding assembly 10, winding core 50 and anchor element 52 is ejected from the cup-shaped housing part 62.

Alternatively, the ejection can also take place in a manner in which the lid assembly 66 and/or the upper contact element 67 do not separate from the winding. In this case, there is only an opening of the cell closure in the region of the crimping. In general, different opening variants and mixtures thereof are possible and the simplified illustrations used here cannot adequately reflect the failure pattern that actually occurs.

The axial form fit between the anchor element 52 and the winding assembly 10 prevents the winding core 50, as a single projectile with its lower mass, from being ejected very quickly from the housing part 62. Instead, the ejected unit has a larger mass in comparison and thus has a significantly lower velocity, which elevates the safety of the energy storage cell 12. Above all, however, a larger portion of the cell mass is ejected, thus significantly reducing the probability of thermal propagation at the cell composite level.

In addition, the reduced radial depth of the indentation 74 allows the winding assembly 10 to move more freely out of the cup-shaped housing part 62 than would be the case with a conventional beading closure technique. As a result, the pressure—or the energy present in the system—is rapidly discharged axially from the housing part 62.

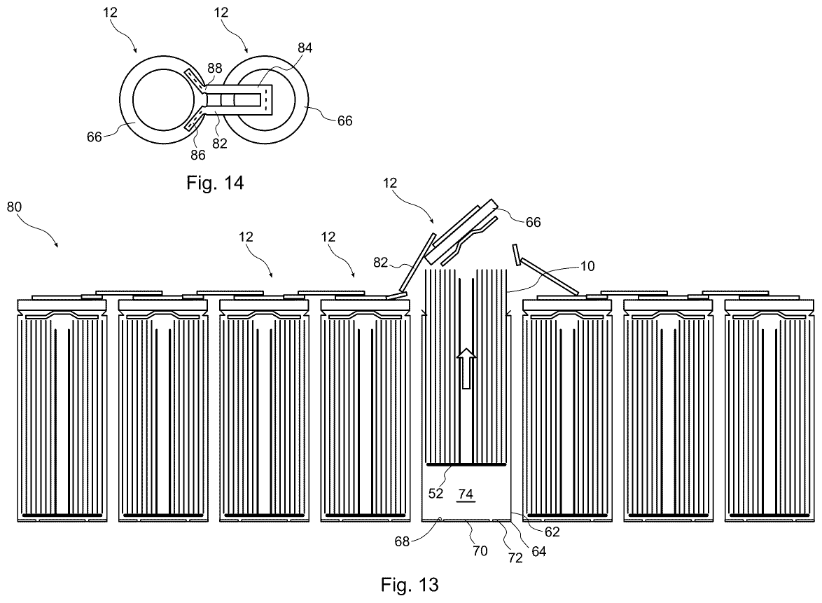

In FIG. 13, the energy storage cell 12 is shown in a cell array 80 comprising several energy storage cells 12 arranged laterally next to one another.

The energy storage cells 12 of the cell array 80 are electrically connected to one another via a cell connector 82. Here, the lid assemblies 66 of two energy storage cells 12 are each connected via a cell connector 82.

The cell connector 82 is designed in such a way that it allows bending or detaches in such a way that the lid assembly 66 of an energy storage cell 12, in which a thermal failure occurs, can detach from the cup-shaped housing part 62.

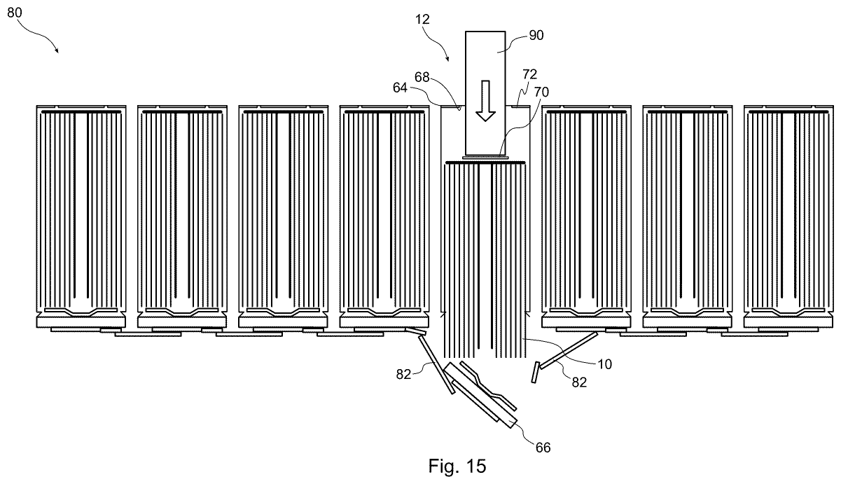

A possible embodiment of such a cell connector 82 is shown in FIG. 14. Here, the cell connector 82 has a base 84, the legs of which merge into contact lugs 86 pointing obliquely outwards. A constriction 88 between the legs and the contact lugs 86 ensures sufficient deformability in the axial direction.

As described above, in the event of thermal failure of an energy storage cell 12 of the cell array 80, the flexible cell connector 82 allows its lid assembly 66 to detach and the winding assembly 10 to be ejected. Due to the fact that the housing 60 opens in the axial direction and the problematic load of the failing winding assembly 10 is also ejected due to the anchor element, the thermal problems do not spread to neighboring energy storage cells 12, or at least to a lesser extent.

The energy storage cell 12 thus elevates safety, especially in the cell array 80.

FIG. 15 shows a step in the recycling process of the cell array 80. For ease of emptying, the cell assembly 80 is arranged in an upside-down orientation.

To remove the winding assembly 10 from the housing 60 of the energy storage cell 12, a plunger 90 is used to press on the detachable base area 70. With sufficient force along the predetermined breaking line 68, this detaches from the remaining base area 72. At the same time, the lid assembly 66 is released, as the crimp closure technology is formed as such that it opens from a predetermined force or from a predetermined pressure. The winding assembly 10 can thus be easily pressed out of the housing 60.

The winding assembly 10 and the housing 60 are then fed separately to further recycling steps.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An electrochemical energy storage element, comprising:
a hollow, cylindrically-shaped winding assembly comprising at least two electrode strips wound spirally around a winding axis and at least one separator strip arranged between the at least two electrode strips, wherein the winding assembly has two terminal end faces, a circumferential outer assembly shell surface, and a circumferential inner assembly shell surface, wherein the inner assembly shell surface defines an axially aligned cavity in a center of the winding assembly;
a winding core with an essentially cylindrical or hollow-cylindrical shape, wherein the winding core is arranged in the axially aligned cavity, wherein the winding core has an outer peripheral surface; and
an anchor element arranged on at least one respective terminal end face of the two terminal end faces of the winding assembly and connected to the winding core, wherein the anchor element projects laterally from the axial center of the winding assembly over the respective terminal end face at least in certain regions.

2. The electrochemical energy storage element according to claim 1 wherein at least one of:
the anchor element and the winding core are integrally formed from the same material,
the anchor element is formed as one or more bent tabs of the winding core,
the anchor element has two, three or four arms,
the anchor element is formed as a disk,
the anchor element extends from the axial center if the winding assembly to a radius that ranges between 10% and 100% of the radius of the winding assembly.

3. The electrochemical energy storage element according to claim 1, wherein the anchor element is an electrically conductive contact element in direct contact with one of the electrode strips at the respective end face.

4. The electrochemical energy storage element according to claim 1, further comprising a housing having a housing part with a bottom and a terminal opening, wherein the terminal opening is closed by a lid assembly.

5. The electrochemical energy storage element according to claim 4, wherein the winding core is connected to the bottom of the housing part such that the bottom forms the anchor element, or
wherein the anchor element is connected to the bottom of the housing part.

6. The electrochemical energy storage element according to claim 4, wherein the anchor element has through openings via which a gas pressure arising in the winding assembly can be released into a space between the bottom and the anchor element, such that the gas pressure presses the anchor element together with the winding core and the winding assembly against the lid assembly.

7. The electrochemical energy storage element according to claim 4 wherein at least one of:
the lid assembly is attached to the cup-shaped housing part by a crimping closure technique such that the closure of the lid assembly opens as soon as the internal pressure and/or the winding composite body presses against the lid assembly with a predetermined threshold pressure; and/or
the lid assembly is attached to the cup-shaped housing part by a crimping closure technique such that the clear cross-section of the cup-shaped housing part is reduced radially in a region below the lid assembly by not more than six times the wall thickness of the housing part compared to a remaining clear cross-section.

8. The electrochemical energy storage element according to claim 4, wherein the bottom has a predetermined breaking line that delimits a detachable bottom region from a bottom region firmly connected to the remaining housing part.

9. The electrochemical energy storage element according to claim 1, wherein the winding core has an outer peripheral surface that lies flat against the inner assembly shell surface.

10. An array of electrochemical energy storage elements according to claim 1, the array comprising:
a cell connector that connects lid assemblies of at least two energy storage elements, wherein the cell connector is deformable and/or detachable such that a respective lid assembly of a first energy storage element can be opened upon reaching a predetermined threshold pressure within the first energy storage element, while lid assemblies of other energy storage elements remain closed.

11. A method for recycling an electrochemical energy storage element according to claim 1, the method comprising:
pressing out the winding assembly from a housing part including the winding core by pressing a punch into a bottom of the energy storage element; and
separately processing the housing part and the winding assembly.
